(19) United States
(12) Patent Application Publication
(10) Pub. No.: US 2023/0060364 A1
(43) Pub. Date: Mar. 2, 2023

(54) TEMPLATE FRAMEWORK WITH AUTOMATED TESTS AND PREVIEWS

(71) Applicant: Meta Platforms, Inc., Menlo Park, CA (US)

(72) Inventors: Syed Faisal KARIM, East Palo Alto, CA (US); Di Zhou, Los Altos, CA (US); Chihung Yu, Newark, CA (US); Leandro Karunungan, Great Neck, NY (US); Yixuan Nie, Milpitas, CA (US)

(21) Appl. No.: 17/737,123

(22) Filed: May 5, 2022

Related U.S. Application Data
(60) Provisional application No. 63/240,261, filed on Sep. 2, 2021.

(51) Int. Cl. G06F 11/36

(52) U.S. Cl. CPC G06F 11/3664; G06F 11/3688; G06F 11/3684; G06F 11/362

(57) ABSTRACT

A system may be configured to: obtain, from a first product development entity, a first set of content; obtain, from a second product development entity different from the first product development entity, a second set of content different from the first set of content; generate a user interface (UI) template configured to be first-applied to the first set of content and second-applied to the second set of content; automatically test, via the first-applied template, functionality associated with the first set of content; determine that the functionality satisfies a criterion of the test; and cause presentation of a first preview of the successfully tested content.

### CROSS-REFERENCE TO RELATED APPLICATIONS

This application claims the benefit of U.S. Provisional Application No. 63/240,261 filed Sep. 2, 2021, the entire content of which being incorporated herein by reference.

### BACKGROUND

Existing web-based software developers may use native templates for mock previews. These mock previews typically merely provide a similar rendering with respect to functionality implemented at a standalone application (app). Additionally, mock previews may be deficient due to the mock preview being based on mobile web features such as, for example, browser-based web features accessible by mobile devices. For example, mobile web features may not support many native template components, which may result in rendering issues such as, for example, rendering issues associated with previews of templates.

Existing solutions may also suffer drawbacks in instances in which apps may not use a native template. With the lack of using a native template, a mock preview may not be available. Additionally, web-based user interface (UI) components may render differently depending upon the operating system. This may further exacerbate rendering problems exhibited by mobile devices.

### SUMMARY

The exemplary embodiments may relate to building a UI template that product development teams may use, which may minimize the inefficiency of each product development team building their own UI rendering. Accordingly, one or more aspects of the present disclosure relate to a method for obtaining, from a first product development entity, a first set of content; obtaining, from a second product development entity different from the first product development entity, a second set of content different from the first set of content; generating a UI template configured to be first-applied to the first set of content and second-applied to the second set of content; automatically testing, via the first-applied template, functionality associated with the first set of content; determining that the functionality satisfies a criterion of the test; and causing presentation of a first preview of the successfully tested content.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 illustrates an exemplary system diagram according to an exemplary embodiment.

FIGS. 2A-2B illustrate exemplary UIs according to exemplary embodiments.

FIGS. 3A-3B illustrate exemplary UIs according to exemplary embodiments.

FIG. 4 illustrates an exemplary UI according to an exemplary embodiment.

FIG. 5 illustrates an exemplary UI according to an exemplary embodiment.

FIG. 6 illustrates a block diagram of a computing device according to an exemplary embodiment.

FIG. 7 is a block diagram of an example computing system according to an exemplary embodiment.

FIG. 8 illustrates a process for generating and/or providing custom previews and/or custom tests for different data sets, in accordance with one or more embodiments.

### DETAILED DESCRIPTION

Each of the embodiments may be disclosed herein in a permissive sense (i.e., meaning having potential of limitation), rather than the mandatory sense (i.e., meaning must). Suitable modifications and variations are contemplated. For example, implementation of an embodiment may be accomplished with one or more of the herein-disclosed operations and/or without some discussed operations. And the disclosed approach may be implemented via electronic storage, user interface devices, networking elements, external resources, and computer processing, including cloud components.

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As defined herein, “units” may refer to ads, and/or promotions or other content items. As an example, one ad/promotion may be one unit.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Operation

Some exemplary embodiments may provide custom previews and custom tests for specific data sets. These previews may be custom since the content may be different for each promotion, advertisement (ad), or other unique content item.

Some exemplary embodiments may generate automated previews and/or automated tests for a given template. The exemplary embodiments may thus minimize the need to develop each UI rendering for specific content items, thereby reducing planning and testing activity to view previews of UI renderings.

The exemplary embodiments may also generate an automated system for users to view the manner in which a unit appears within a user interface. For example, when developing an ad, a developer may want to view a preview of the ad. But such preview of the ad may not be a real/accurate preview of the ad. Rather, the preview may be a mock preview (e.g., web-based) that may look similar to the real ad but may lack details. Accordingly, the exemplary embodiments may generate a template for improving previewing of developed promotions, ads, and/or other types of content items.

The exemplary embodiments may facilitate standardizing and simplifying of app designing. In this regard, the exemplary embodiments may simplify and standardize app design by implementing a standard template (i) which product (e.g., app) developers may utilize to test product functions to ensure that app functionality operates properly, and (ii) in which content can be input to a UI template. By utilizing the UI template(s) of the exemplary embodiments, product developers may avoid building/creating tailored template(s) for UI components and may avoid the building/creating of UI rendering tools. The UI template(s) provided by the exemplary embodiments may be customizable to handle any kind of content, and may include automated testing and previews associated with content of products/apps, which product developers may utilize.

The exemplary embodiments may enable multiple development teams to develop functionality for different apps using the same UI template compatible with smart devices and their operative platforms (e.g., operating systems (OSs)). In some embodiments, an entity that developed a computer program or product implementing the herein-disclosed approach may be different from product development entities from which sets of content may be obtained.

In some embodiments, image (e.g., screenshot) service 9 may be provided, e.g., to preview and test functionality of an app. Some apps described herein may support native templates while some other apps may not support native templates, and even if these or other apps may not support the mobile web, the exemplary embodiments may still render a quality preview.

The exemplary embodiments may be employed to develop different UIs using the same template for different platforms (e.g., different OSs). In an example embodiment, this approach may be platform independent (e.g., operate on different OSs). A UI template may support multiple, different promotions, e.g., for standardizing a UI.

The exemplary embodiments may facilitate a mechanism for providing previews and testing of UIs. Some exemplary embodiments may enable users to minimize, or avoid performing multiple tests for target devices using different platforms to save app development time.

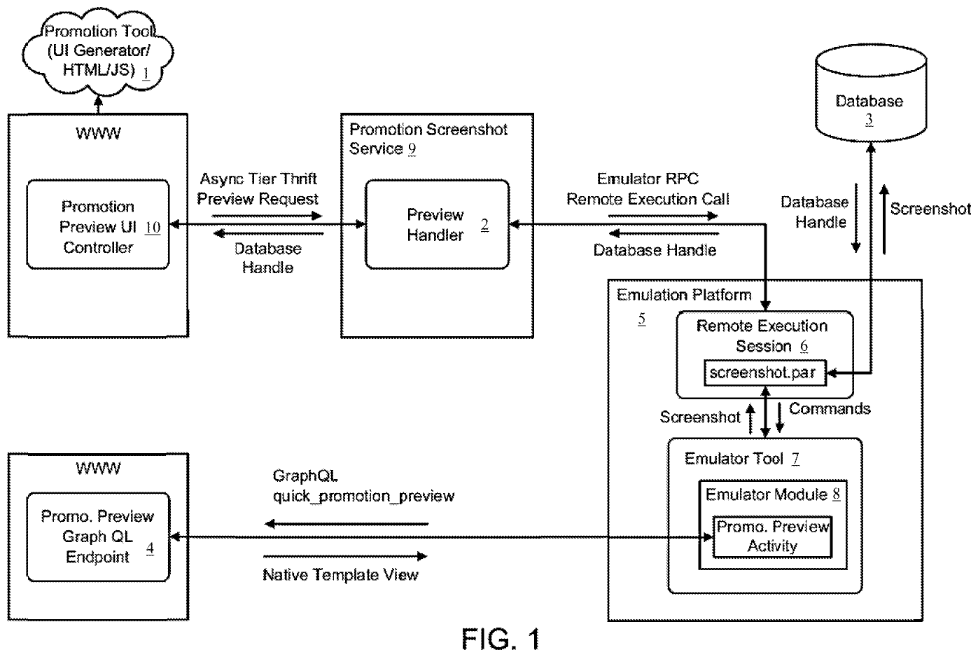

The exemplary embodiments may also be used to create a framework in which the UI may be rendered independently of the data. As such, multiple different app development teams may provide data to the same UI. This approach may provide improvements by providing automated tests and previews. For example, by utilizing the exemplary embodiments, users may supply mock data for their specific unit, and a test(s) may be generated to check the operation/functionality of the unit. The exemplary embodiments may also generate a preview for applications that may have different platforms (e.g., different OSs) on different target devices (e.g., mobile phones, tablets, laptops, etc.). The exemplary embodiments may thus enable the systems (e.g., system of FIG. 1) described herein to scale for many different types of apps.

Some exemplary embodiments may enable some services to scale beyond their existing service functionality. One exemplary type of scaling may enable different product development teams to utilize the same UI template for different products (e.g., apps). For example, the UI template may be employed for use by various services (e.g., app services) that may be utilized by different social groups on social networks. As such, the exemplary embodiments may scale across multiple different products/apps.

The exemplary embodiments may enable automated tests of the UI associated with an app. For example, a test may be implemented by the exemplary embodiments to determine whether a UI renders (e.g., displays a unit) correctly. Another example test may involve testing of tasks, such as, for example, whether a button's actuation (e.g., click) associated with an app feature functions properly. Another example may be to test/determine whether a video of a horizontal scroll (H-Scroll) associated with an app feature functions properly. These automated tests of the UI are exemplary in nature and any other suitable automated tests of the UI may be performed by the exemplary embodiments.

A promotion may be a way for a family of apps to enable communication to one or more users. For these communications, the UI associated with the app(s) may, but need not be, the same. In some of exemplary embodiments, the content associated with the UI and/or the communications may be different.

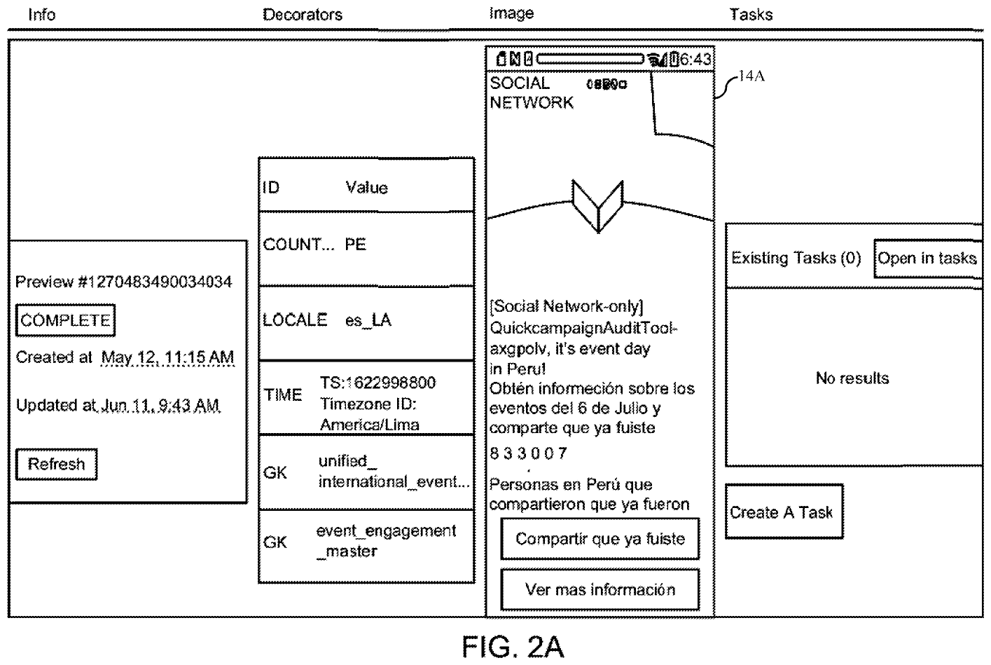

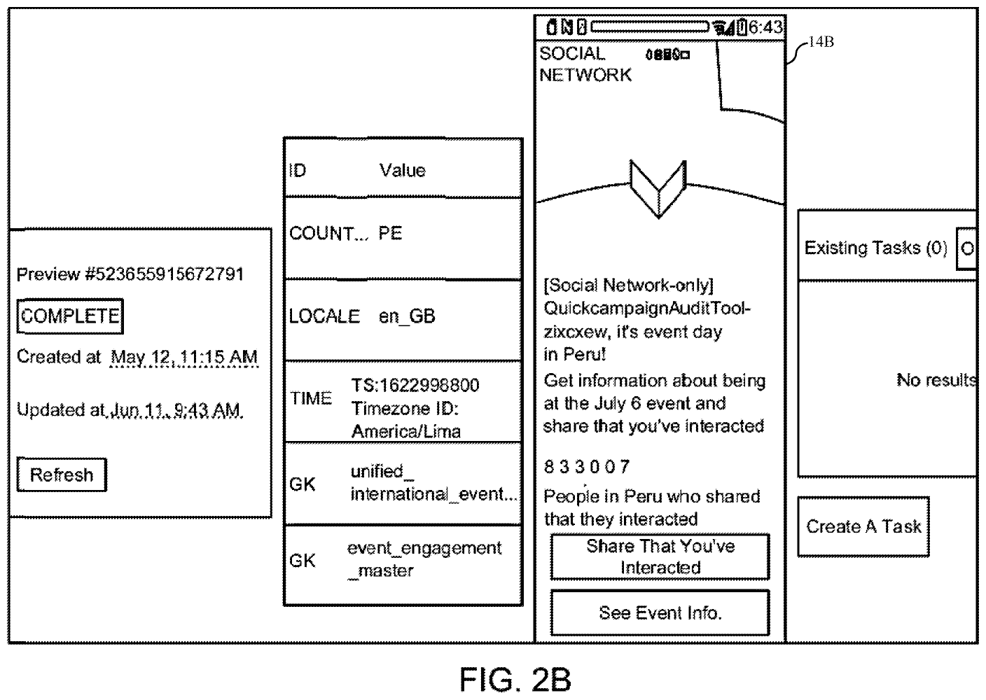

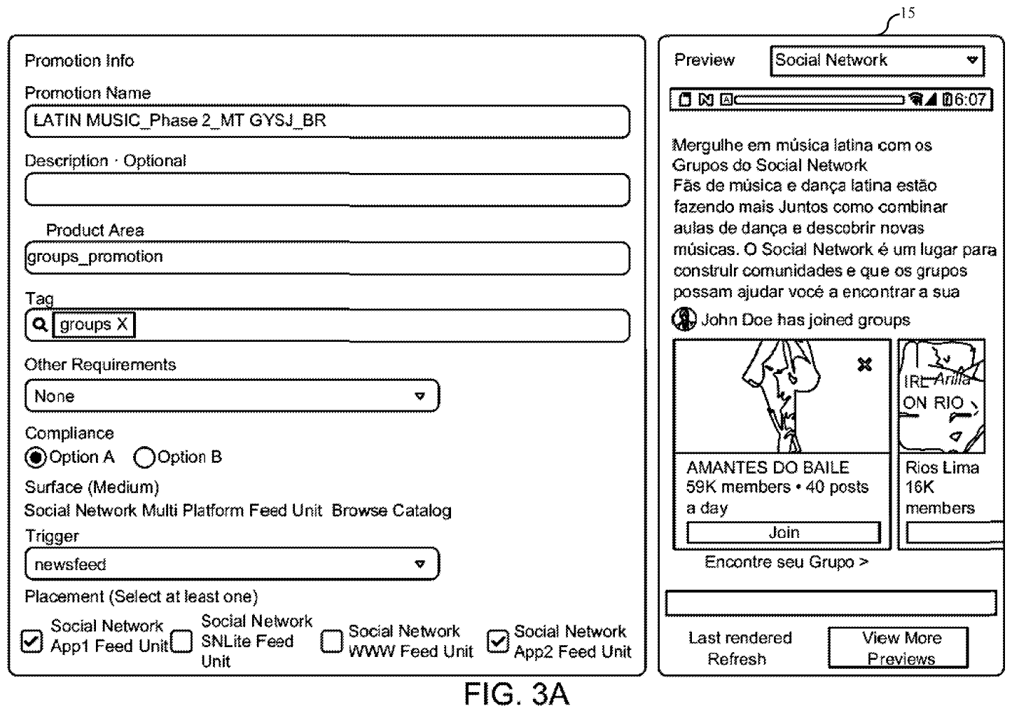

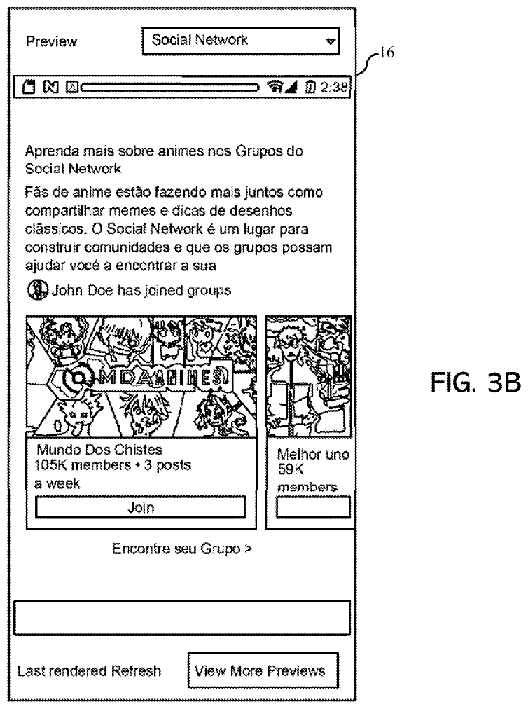

The exemplary embodiments may provide a flexible approach for (e.g., online or web) app designers to allow the designers to custom preview and automatically test their apps. More specifically, the system of the exemplary embodiments may be flexible in that they may facilitate usage of the same/similar UI template in some instances and in other instances may employ multiple, different UI templates. For instance, FIGS. 3-5, described more fully below, may illustrate usage of an exemplary H-Scroll UI template. As another example, FIGS. 2A-2B described more fully below, may illustrate an event template (e.g., Peruvian event template) in which the content of FIG. 2A and FIG. 2B may be different even in an instance in which the same event template may be employed. Another way the disclosed framework may be flexible is, for the same UI template, it may use any kind of data.

By providing a custom UI template, the exemplary embodiments may minimize overall extensive runtime associated with tasks (e.g., software tasks) of apps by avoiding a need to implement multiple UIs for each of different apps that may be developed and employed by different product developers or development teams. Some examples of these tasks (e.g., software tasks) may involve creating the UI, such as for example an H-Scroll UI template to create the title, subtitle, and actual cards to enable pagination. In an instance in which the UI is created, the exemplary embodiments may test one or more of the associated tasks. The exemplary embodiments may also include a login task which may be tested (e.g., to ensure that the login operates properly).

The exemplary embodiments may also reduce unexpected troubleshooting during the app test procedure by users (e.g., developers). The exemplary embodiments may reduce the troubleshooting by providing different automated testing of the app in previews (e.g., UI rendering previews of an app and/or unit(s)).

Referring now to FIG. 1, a system according to an exemplary embodiment is illustrated. The system may include promotion tool 1 (e.g., a UI Generator/HTML/JS module), which may be a front-end HTML (HyperText Markup Language) and JavaScript (JS) library for creating one or more UIs or UI components and may be configured to interact with promotion preview UI controller 10. Promotion preview UI controller 10 may be utilized by one or more users (e.g., different app team developers) and promotion preview UI controller 10 may implement, and enable usage of, the same/similar UI template by different users (e.g., the different app team developers). In some example embodiments, promotion preview UI controller 10 may receive user input of a request or a request from a user device (e.g., a mobile device) with an indication of parameters for a type of promotion and the request may indicate a parameter for a language (e.g., English, Spanish, etc.) for the promotion, as well as a parameter for style and other parameters/features.

The parameters may be sent, by promotion preview UI controller 10, to preview handler 2 of FIG. 1 which may store the parameters and other information in a memory device such as database 3 of FIG. 1 (for example, storing the parameters/information for future reference). Promotion preview UI controller 10 may also generate a request that may be sent to the preview handler of promotion screenshot service 9 of FIG. 1, which may be a service for generating one or more images (e.g., screenshots) of a content item (e.g., a promotion(s)/ad(s)). Preview handler 2 may communicate with the emulation platform service (also referred to herein as emulation platform 5) of FIG. 1 to schedule one or more previews of the images of the content item (e.g., the promotion(s)/ad(s)).

Promotion preview UI controller 10 of FIG. 1 may send a communication to preview handler 2 of promotion screenshot service 9 informing preview handler 2 regarding the type of the content item (e.g., the promotion/ad). In this regard, the communication may include an identifier which may indicate which app the content item may be associated with for rendering (e.g., a preview display of the content item).

As such, in the example of FIG. 1, preview handler 2 may generate a preview (e.g., an app preview for display via a display device) which may be associated with the content item of the app. Emulation platform 5 may perform such services as (i) receiving an image (e.g., a screenshot) of the app preview associated with the content item and/or (ii) uploading or storing the image to a network device (e.g., database 3 of FIG. 1 and/or a web server). In this regard, one or more users (e.g., developers of app teams) may access and view the app preview of the image associated with the content item of the app and may approve the app preview.

In the example embodiment of FIG. 1, remote execution session 6 (also referred to herein as a remote execution session module) of emulation platform 5 may send a communication to preview handler 2 of promotion screenshot service 9 to indicate that one or more images generated as previews, by preview handler 2, are successfully stored (e.g., in database 3 of FIG. 1). In the example embodiment of FIG. 1, database 3 may generate a database handle(s), which may be a key(s) to an image(s)/screenshot(s) and the database handle may be included (for example by the remote execution session module) in the communication sent to preview handler 2 informing of the successful storage of the image. In some example embodiments, the database handle as the key may be used to fetch the preview of the image at a later time.

Emulator module 8 of emulator tool 7 of FIG. 1 may facilitate rendering of a content item (e.g., a unit) such as for example an image of an app preview associated with a promotion (referred to as “promo. preview activity” in FIG. 1). In the example embodiment of FIG. 1, emulator module 8 may render (e.g., display) the content item based on analyzing a promotion identifier (e.g., a promotion ID) indicating the manner in which the content item should be rendered and which indicates to the emulation module to fetch the data associated with the content item for rendering. A graph query language (QL) may be associated with the promotion identifier for fetching the data associated with the content item to be rendered. In some example embodiments, the QL may be associated with an application programming interface(s) (APIs).

In the example embodiment of FIG. 1, emulator tool 7 may include an audit tool which may automate preview generation for each of the images of the content items associated with apps (e.g., stored in database 3 of FIG. 1) and may generate an assessment of the quality of the previews to automatically determine whether there are any issues with the previews. In some example embodiments, one or more users (e.g., quality assurance (QA) personnel) may also view each of the previews and determine whether the previews look acceptable. If there are any determined issues with a preview (e.g., as determined by the audit tool of emulator tool 7), the emulation tool may provide a function (e.g., via a button of a user interface) indicating a task to correct the preview. The task may indicate to a user (e.g., QA personnel) to analyze the preview to correct the preview for proper viewing. On the other hand, in an instance in which the audit tool may determine that quality of a preview is good, emulator tool 7 may not generate a task for any correction of a preview. In this manner, emulator tool 7 may enable app previews to go through an approval process. An emulation platform subsystem (also referred to herein as emulation platform 5 of FIG. 1) may perform testing on app previews which may be stored in database 3.

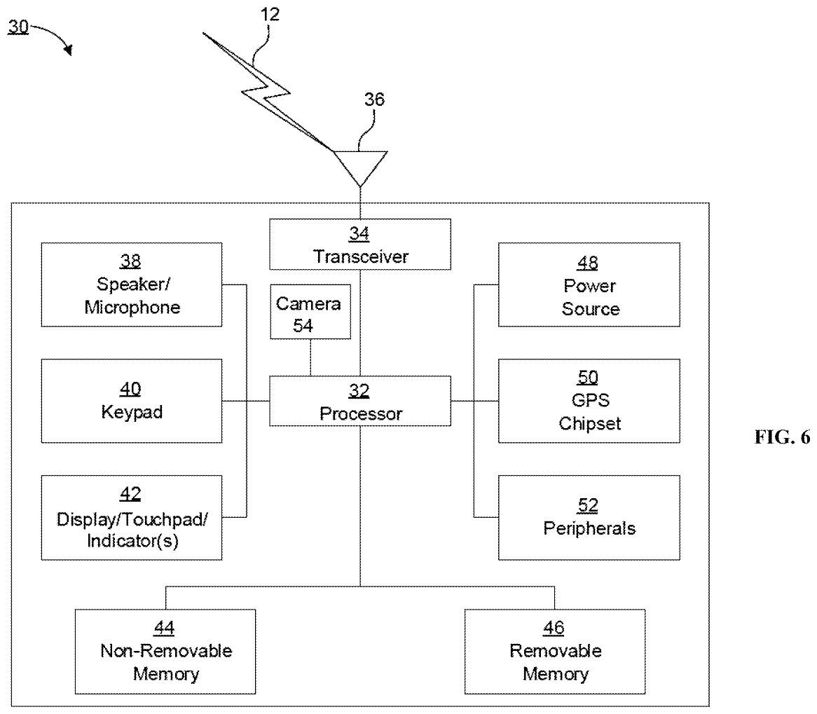

The emulation platform subsystem may include an emulator infrastructure that may maintain a pool of executable/running emulators. The emulation platform subsystem may include a remote emulator infrastructure and remote execution session 6 of FIG. 1. Emulation tasks may be shared with end to end (e2e) software for automated testing. The emulator platform subsystem may utilize an emulator, of the pool of emulators, to run a corresponding test. In this regard, for example, the emulator platform subsystem may borrow an emulator from the pool from which to run a preview test (or any other suitable test). The emulation platform subsystem may provide test feedback to preview handler 2 and the test feedback may be stored in database 3 of FIG. 1. For example, the test feedback (e.g., feedback associated with a preview test) may indicate pass or fail and may include data indicating a particular error. An image of the error may be captured and included in the test feedback. A user (e.g., QA personnel) may analyze the captured image indicating the error to debug and correct the error. In some example embodiments, the emulation platform subsystem may also provide a testing framework for testing specific kinds/types of UI components. In some other exemplary embodiments, the emulation platform subsystem may employ/execute a deep link feature to perform one or more functionality tests such as, for example, checking whether button functionality of a UI operates properly when clicked. In addition, the emulation platform subsystem may include machine hosting which may allow for running/executing complex code and which may save a lot of software runtime thereby improving the functioning of the emulator platform subsystem and the functioning of the system of FIG. 1 by conserving processing resources (e.g., processor/controller device(s)) associated with minimizing runtime. For example, the emulation platform subsystem (e.g., via the remote session execution module) may enable running/execution of complex code on a machine (e.g., computing device 30 of FIG. 6) hosting the emulator, which may conserve a lot of execution round trips. The emulator platform subsystem may receive a script of commands (which may reduce a need to make multiple execution trips) for execution of the commands rather than receiving each command separately for execution which may require multiple execution trips. In other words, the execution platform subsystem may receive a full script (e.g., one packet of a plurality of commands) of all relevant commands to run and may run/execute all of the commands (e.g., at a same runtime) which may conserve processing resources rather than receiving each command and running each command one-by-one, which may increase the round trips and the execution time and thereby may inefficiently drain processing resources. As described above some of the commands include, but are not limited to, a command to open a display screen, to fetch/retrieve a unit (e.g., promotion/ad), a command to render an image (e.g., an app preview screenshot), etc.

The remote execution session module of the emulator platform subsystem may communicate with emulator module 8 to perform certain commands/operations. For example, some of these commands (e.g., software code) may instruct emulator module 8 to open a screen (e.g., a screen of a display device), to load a promotion/ad, click on a button, widget or the like, etc. In some example embodiments, these commands may include debug bridge (DB) commands for example to debug features (i.e., in an instance of a malfunction). In some exemplary embodiments, the debug commands may be included in a package and may be associated with a script informing the emulator platform subsystem of commands to run to troubleshoot for example a preview image (e.g., an app preview screenshot). Some of these commands may also be utilized to facilitate automation of the emulator platform subsystem.

In some exemplary embodiments, the emulation platform subsystem may generate debug logs indicating one or more determined debugs. For example, the emulation platform subsystem may determine that if a preview of a content items fails a quality check, the emulation platform subsystem may provide a reason regarding the failure in a debug log(s). A user (e.g., QA personnel) may be able to access and review the debug log(s) indicating the reason for the failure.

Emulator module 8 of emulator tool 7 may be configured to facilitate remote execution sessions 6, e.g., which may be performed locally on a computing device (e.g., computing device 30 of FIG. 6) including the components of the system of FIG. 1 or remotely on a (e.g., external/local) device (e.g., a local client device or server device). The remote device may include emulators to perform certain functionality (e.g., the testing and/or debugging described above).

In the example of FIG. 1, the emulator platform subsystem may perform a remote procedure call (RPC) to request preview handler 2 to generate a preview of a content item (e.g., app preview) and to provide the preview result, which may be generated by preview handler 2, to the emulator platform subsystem.

Emulator module 8 of emulator tool 7 may include promotion (promo.) preview activity associated with a content item (e.g., a promotion/ad) for rendering which may rendered by emulator module 8 and or may be communicated by emulator module 8 to promotion preview graph query language endpoint 4 (e.g., a node device, a network device, etc.). In some exemplary embodiments, promotion preview graph QL endpoint 4 may enable users (e.g., app users/developers) to detectably interact with the promotion preview activity for testing and previewing purposes. In some example embodiments, promotion preview graph QL endpoint 4 may be remote from the emulator platform subsystem. In other alternative example embodiments, promotion preview graph QL endpoint 4 may be embedded within the emulator platform subsystem.

The system of FIG. 1 may enable one or more users (e.g., of different platform/product development teams) to build/create various different units (e.g., for different development teams (e.g., an event team, health team, etc.)) which may be previewed and tested in a same/similar UI provided by the framework of the system of FIG. 1. The UIs provided by the exemplary embodiments of the system of FIG. 1 may be configured to enable preview of units for rendering and may be app independent and platform independent (e.g., independent of different OSs (e.g., mobile OSs)).

The exemplary embodiments may increase optimization by saving time. For example, in previous approaches, if a user wanted to obtain an ideal preview, a typical manner in which to do so may involve a manual approach on a device. Additionally, in previous approaches if the user wanted to consider multiple different locales for an ideal preview, the user may need to manually open and change the locale using the device. These manual approaches for generating a preview are cumbersome and take a lot of time, for example on the order of hours in some instances. By utilizing the exemplary embodiments, an ideal preview of a content item may be automated and take considerably less time to automatically generate (e.g., 50 seconds or less, 40 seconds or less, 30 seconds or less, 20 seconds or less, 10 seconds or less, etc.). In so doing, the architecture improves computer functionality by reducing the processing power required to open multiple locales in view of user selections. The architecture also improves upon the technology by greatly reducing time spent troubleshooting in view of the particular arrangement of the UI previews on a display.

Examples of previews of units generated by the system of FIG. 1 may include H-scroll UIs and others may be non-H-scroll UIs. Referring now to FIGS. 2A and 2B, preview 14A, 14B of a non-H-scroll event unit may be shown in the examples of FIGS. 2A and 2B, which may be in different languages (e.g., Spanish, Portuguese). Previews 14A-14B of units in the UI shown in the examples of FIGS. 2A and 2B may be platform independent (e.g., may operate independently of different OSs). Preview 15 of a Latin music H-Scroll unit, including rendered content, and another such preview 16 of an anime H-Scroll unit, including rendered content, may be shown in the examples of FIGS. 3A and 3B as described more fully below. The examples of FIGS. 2A and 2B may illustrate another example of a different type of unit (e.g., associated with events) exemplifying a similar concept being presented in a same type of UI as generated by the system of FIG. 1. By viewing the UI of the examples of FIGS. 2A and 2B one or more users (e.g., product developers) may view unit previews 14A, 14B in the UI to determine if the unit previews appear properly. In an alternative example embodiment, the UI of the examples of FIGS. 2A and 2B may enable a user to click on a view feature enabling multi-views and the UI may get more specific. A user may also make a selection (e.g., in the UI) to request a specific locale (e.g., Peru, Brazil). A user may request/make a selection of a particular promotion to view what the associated content within the UI looks like in a specific language or in several different languages (as in FIGS. 2A and 2B for example).

Referring now to FIG. 3A, example preview 15 of a music promotion according to an exemplary embodiment is provided for purposes of illustration and not of limitation. FIG. 3B shows an example preview 16 of an anime promotion unit for purposes of illustration and not of limitation. The UI of the examples of FIGS. 3A and 3B may be generated by the system of FIG. 1. These examples may have a similar UI but with different content. For example, one content item may be about anime (e.g., FIG. 3B) and the other content item may be about Latin music (e.g., FIG. 3A). In other example embodiments, there may be other content items in the UI of FIGS. 3A and 3B, such as for example, content items about friends. Accordingly, exemplary embodiments may enable multiple different teams to create a UI for similar use cases rather than having each different team create their own specific UI. In this manner, the exemplary embodiments may facilitate creation of a UI for similar types of content, which may be built/created once and each team may import relevant data associated with the content item (e.g., a promotion/ad) into the UI.

At the bottom portion of FIG. 3A, a user may select, via check boxes of the UI, one or more different placements for different apps (and/or different OSs). In the example of FIG. 3B, the content of the promotion may be different from the content of the similar UI of FIG. 3A. As such, the exemplary embodiments may be flexible, e.g., by showing different content which may be input to the UI by different users (e.g., different developer teams). Another way the exemplary embodiments may be flexible may be in terms of the generated templates. For example, the system of FIG. 1 may generate an H-Scroll template based on a type of content item (e.g., a type of ad). However, a user may utilize the audit tool of the emulation tool to select other types of templates for content items (e.g., the template of FIGS. 2A-2B) for UI rendering of the associated content item. In this manner, users (e.g., product team developers) may input content to a selected UI template and the emulation tool of the system of FIG. 1 may render exact unit previews (e.g., 14A, 14B, 15, and/or 16) for the content item.

According to one or more of the exemplary embodiments, the framework of the system of FIG. 1 may enable some customizations of a UI. For example, some exemplary embodiments may provide some parameters to enable users (e.g., product developers) to perform minimal customizations, such that the UIs may not appear very different from each other. In this manner, the exemplary embodiments may allow the users (e.g., product developers) to change a few aspects of UIs.

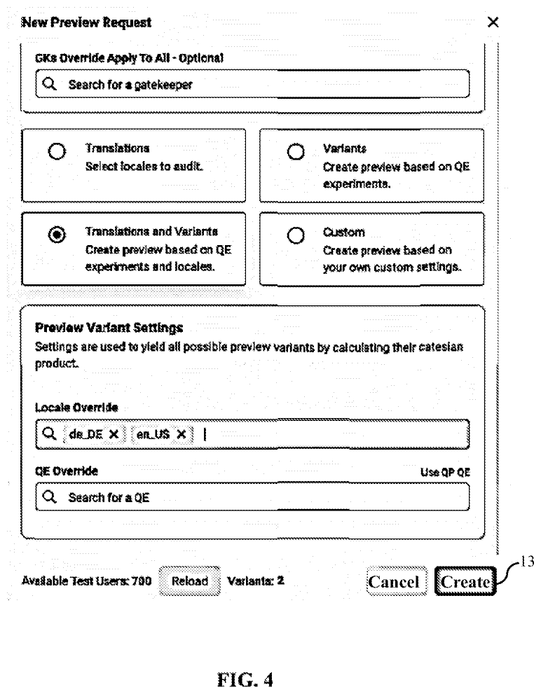

Referring now to FIG. 4, a UI depicting content that is presented to the UI in an instance in which a user clicks button 13 of the UI to create previews is provided according to an exemplary embodiment. As such in the example of FIG. 4, the system of FIG. 1 may generate multiple different promotions which may have the same or similar UI template. In this regard, the system of FIG. 1 may standardize the UI (e.g., multiple promotions may utilize an H-Scroll template).

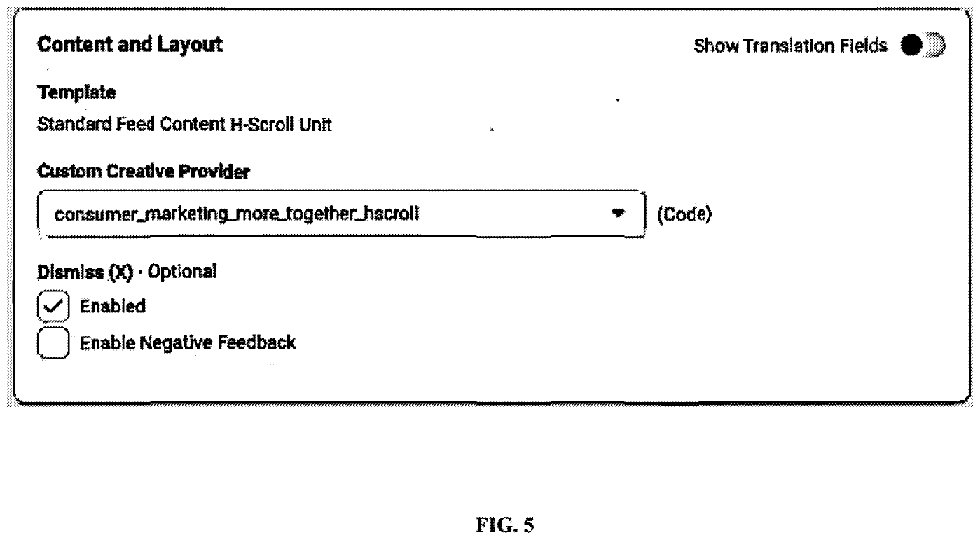

FIG. 5 may illustrate an example of a UI template, which indicates content and layout. The system of FIG. 1 may generate different templates, one of which is illustrated in FIG. 5 having a template standard feed content H-Scroll unit. Each template generated by the system of FIG. 1 may be used for multiple apps.

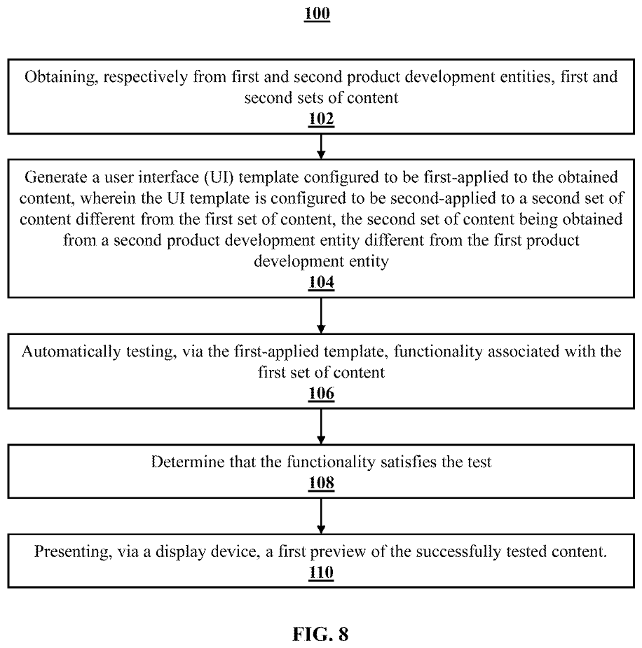

FIG. 8 illustrates method 100 for generating and/or providing custom previews and/or custom tests for different data sets, in accordance with one or more embodiments. Method 100 may be performed with a computer system comprising one or more computer processors and/or other components. The processors are configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 8 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

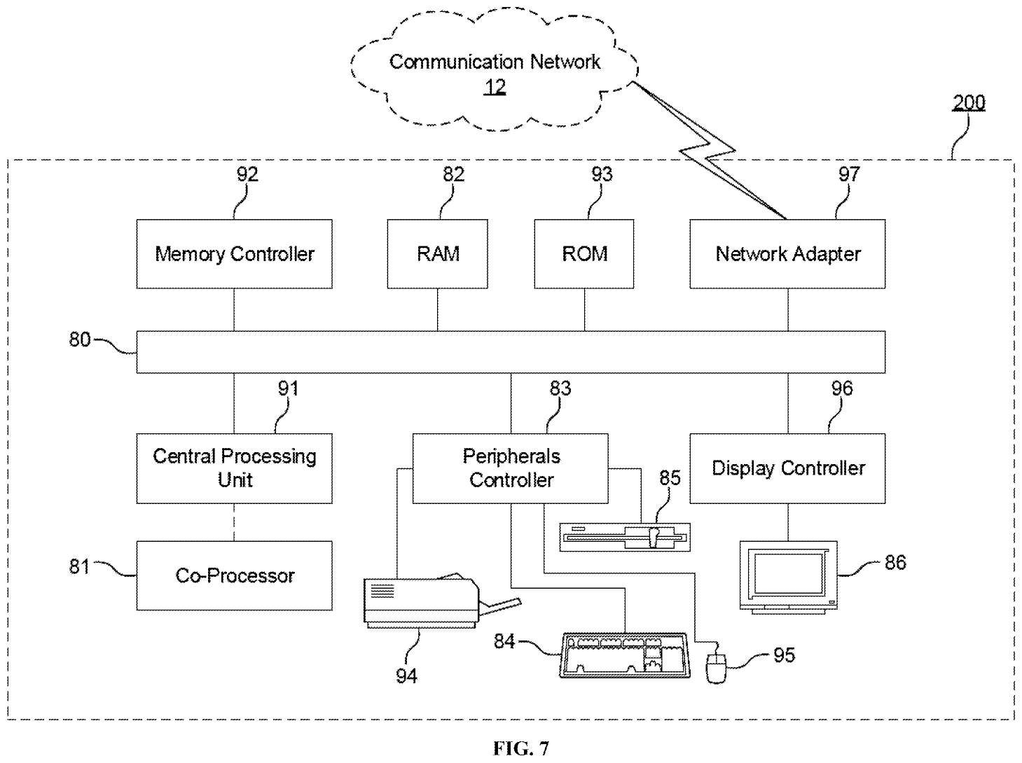

At operation 102 of method 100, a first set of content may be obtained, from a first product development entity. And a second set of content different from the first set of content may be obtained from a second product development entity different from the first product development entity. In some embodiments, operation 102 may be performed by a component of processor(s) 32 and/or central processing unit (CPU) 91 (shown in FIGS. 6-7 and described herein).

At operation 104 of method 100, a UI template configured to be first-applied to the first set of content and to be second-applied to the second set of content may be generated. In some embodiments, operation 104 may be performed by a component of processor(s) 32 and/or CPU 91 (shown in FIGS. 6-7 and described herein).

At operation 106 of method 100, functionality associated with the first set of content may be automatically tested, via the first-applied template. In some embodiments, operation 106 may be performed by a component of processor(s) 32 and/or CPU 91 (shown in FIGS. 6-7 and described herein).

At operation 108 of method 100, whether the functionality satisfies a criterion of the test may be determined. In some embodiments, operation 108 may be performed by a component of processor(s) 32 and/or CPU 91 (shown in FIGS. 6-7 and described herein).

At operation 110 of method 100, presentation of a first preview of the successfully tested content may be caused to be performed. In some implementations, a promotion, preview, or another contemplated presentation at a UI may be, e.g., a realistic representation or a visual draft of the design of a website or a web/mobile application. It may reflect the app's or the site's design elements, such as the color scheme, images, logos, typography, buttons etc., hence representing the final appearance of the app's interface. In some embodiments, operation 110 may be performed by a component of processor(s) 32 and/or CPU 91 (shown in FIGS. 6-7 and described herein).

### Exemplary System Architecture

FIG. 6 may be a block diagram of a computing device 30 for an exemplary hardware/software architecture of the foregoing framework. In an example embodiment, the computing device 30 may include the components of the system of FIG. 1. The computing device 30 may include a processor 32, non-removable memory 44, removable memory 46, a speaker/microphone 38, a keypad 40, a display, touchpad, and/or indicators 42, a power source 48, a global positioning system (GPS) chipset 50, other peripherals 52, and/or a camera 54. The computing device 30 may also include transceiver 34 and a transmit/receive element 36.

The processor 32 may be a general-purpose processor, a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) to perform the various required functions of the framework. For example, the processor 32 may perform signal coding, data processing, power control, input/output processing, and/or any other functionality that enables operation in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 may be coupled to its communication circuitry (e.g., transceiver 34 and transmit/receive element 36). The processor 32, through the execution of computer executable instructions, may control the communication circuitry in order to cause communication with a network to which it may be connected.

The transmit/receive element 36 may be configured to transmit signals to, or receive signals from, other components or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. The transceiver 34 may include multiple transceivers for enabling a component of the framework to communicate via multiple radio access technologies RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that may be not physically located locally, such as on a server or a home computer.

The processor 32 may receive power from the power source 48 and may be configured to distribute and/or control the power to the other components of the framework. The power source 48 may be any suitable device for powering.

The processor 32 may also be coupled to the GPS chipset 50, which may be configured to provide location information (e.g., longitude and latitude) regarding the current location of a framework component.

FIG. 7 may be a block diagram of an exemplary computing system 200 which may also be used to implement components of the system framework. The computing system 200 may comprise a computer or server and may be controlled primarily by computer readable instructions, which may be in the form of software, wherever, or by whatever means such software may be stored or accessed. Such computer readable instructions may be executed within a processor, such as CPU 91, to cause computing system 200 to operate. In many known workstations, servers, and personal computers, CPU 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 200 and defines the medium for data exchange. System bus 80 typically includes data lines for sending data, address lines for sending addresses, and control lines for sending interrupts and for operating the system bus. An example of such a system bus 80 may be the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 200 may contain peripherals controller 83 responsible for communicating instructions from CPU 91 to peripherals, such as printer 94, keyboard 84, mouse 95, and disk drive 85.

Display 86, which may be controlled by display controller 96, may be used to display visual output generated by computing system 200. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that may be sent to display 86.

Further, computing system 200 may contain communication circuitry, such as for example a network adaptor 97, that may be used to connect computing system 200 to an external communications network, such as network 12 of FIG. 6, to enable the computing system 200 to communicate with other components of the network.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A computer-implemented method, comprising:
obtaining, from a first product development entity, a first set of content;
obtaining, from a second product development entity different from the first product development entity, a second set of content different from the first set of content;
generating a user interface (UI) template configured to be (i) first-applied to the first set of content and (ii) second-applied to the second set of content;
automatically testing, via the first-applied template, functionality associated with the first set of content;
determining the functionality satisfies a criterion of the test; and
causing presentation of a first preview of the tested content.

2. The method of claim 1, further comprising:
presenting, via the UI template second-applied at a display device, a second preview of the second set of content,
wherein the second set of content is of a similar type as the first set of content.

3. The method of claim 2, wherein:
the first preview is performed via at least one of a first operating system (OS), first type of user device, or first application, and
the second preview is performed via at least one of a second OS, second type of user device, or second application different from at least one of the first OS, the first type of user device, or the first application, respectively.

4. The method of claim 1, further comprising:
generating at least one of a UI or UI component configured to promote the tested content associated with an online application; and
generating the test.

5. The method of claim 1, further comprising:
displaying, via a detected interaction by a user at a UI, mock data at the first preview.

6. The method of claim 1, further comprising:
selecting, via a detected interaction at a UI by a user indication, at least one of a different language or style; and
presenting, via a display device, a second preview of the tested content in at least one of the at least one selected language or style.

7. The method of claim 1, further comprising:
obtaining, from a pool of emulators, one emulator configured to perform at least one of the test or the first preview.

8. The method of claim 7, wherein the performance is based on a script of debug commands, at least one of the debug commands being configured to open a screen, load the first set of content, or actuate a UI button.

9. The method of claim 2, further comprising:
automatically testing other functionality associated with the first set of content; and
capturing, via the display device, a screenshot such that a failure associated with the testing of the other functionality is debugged.

10. The method of claim 3, wherein the first application or the second application does not support use of a native template.

11. The method of claim 1, further comprising:
storing, via a database, the first preview;
generating, via the database, a handle configured to be used as a key; and
obtaining, at a later time, the first preview based on the handle.

12. The method of claim 7, further comprising:
providing, to a quality assurance (QA) user, the first preview such that a determination is performed as to whether the first preview is acceptable; and
upon a determination of an issue with the first preview, providing, via the one emulator, an indication of a task to correct the issue.

13. The method of claim 4, wherein the functionality relates to a logging-in operation at the online application.

14. The method of claim 9, further comprising:
transmitting, to a preview handler of a promotion service that performed the capturing of the screenshot, an identifier of the content type to indicate an application associated with the first preview.

15. The method of claim 12, further comprising:
automatically previewing, via an audit tool, a plurality of images, resulting in automatic previews; and
generating, via the audit tool, an assessment of a quality of the automatic previews to determine presence of at least the issue.

16. A non-transitory, computer-readable medium comprising instructions executable by at least one processor to perform a method, the method comprising:
obtaining, from a first product development entity, a first set of content;
obtaining, from a second product development entity different from the first product development entity, a second set of content different from the first set of content;
generating a UI template configured to be (i) first-applied to the first set of content and (ii) second-applied to the second set of content;
automatically testing, via the first-applied template, functionality associated with the first set of content;
determining that the functionality satisfies a criterion of the test; and
causing presentation of a first preview of the tested content.

17. The medium of claim 16, wherein the method further comprises:
the obtaining of the second set of content, wherein the second set of content is of a similar type as the first set of content; and
presenting, via the second-applied template, a second preview of the second set of content.

18. The medium of claim 17, wherein the first preview is performed via at least one of a first OS, first type of user device, or first application, and
wherein the second preview is performed via at least one of a second OS, second type of user device, or second application different from at least one of the first OS, the first type of user device, or the first application, respectively.

19. The medium of claim 16, wherein the method further comprises:
generating at least one of a UI or UI component configured to promote the tested content associated with an online application.

20. The medium of claim 16, wherein the method further comprises:
providing, via interaction at another UI by a user, mock data to be displayed at the first preview; and
generating the test.
